(19) United States
(12) Patent Application Publication
(10) Pub. No.: US 2011/0009513 A1
(43) Pub. Date: Jan. 13, 2011

(54) Imide-Coupled Propylene-Based Polymer and Process

(75) Inventors: Bharat I. Chaudhary, Princeton, NJ (US); Rongjuan Cong, Lake Jackson, TX (US); John Scott Parent, Kingston (CA)

Correspondence Address: Ted J. Barthel;Whyte Hirschboeck Dudek S.C., Suite 1900, 555 E. Wells Street, Milwaukee, WI, 53202, US

(73) Assignees: Dow Global Technologies, Inc., Midland, MI (US); Queen's University at Kingston, Kingston (CA)

(21) Appl. No.: 12/831,394

(22) Filed: Jul. 7, 2010

Related U.S. Application Data
(60) Provisional application No. 61/223,781, filed on Jul. 8, 2009.

(51) Int. Cl. C08F 255/00

(52) U.S. Cl. 521/134; 525/190

(57) ABSTRACT

Disclosed are propylene-based polymers with improved melt strength, improved strain hardening characteristics and processes for producing the same. The processes include reacting a polyamine with a maleic anhydride-grafted-propylene-based polymer. The processes produce a rheology-modified propylene-based polymer with long chain branching by forming a polyimide linkage which couples polymer chains of the propylene-based polymer. The polyimide-coupled propylene-based polymer exhibits improved melt strength and improved strain hardening characteristics.

### CROSS-REFERENCE TO RELATED APPLICATIONS

This application claims the benefit of U.S. Provisional Application No. 61/223,781 filed Jul. 8, 2009.

### BACKGROUND

Polypropylene has a linear structure resulting in low melt strength which makes it ill-suited for certain melt state processes. Accordingly, polypropylene with linear structure is unsuitable for applications such as blown films, extrusion coating, foam extrusion, and blow-molding. Known are chemical processes that modify polypropylene to increase its melt strength. For example, it is known to increase melt strength by generating long-chain branching (LCB) through chemical modification of polypropylene—i.e., azide coupling, electron beam radiation, free radical functionalization. The demand for polypropylene continue to grow as applications for polypropylene become more diversified and sophisticated. Consequently, the art has a continuous need to develop alternate technologies for enhancing the properties of polypropylene.

Desirable is a propylene-based polymer with enhanced melt strength. Further desired is an improved process for producing propylene-based polymer with long-chain branching to improve melt strength.

### SUMMARY

The present disclosure is directed to olefin-based polymers, and in particular, propylene-based polymers with improved melt strength. The rheology of the propylene-based polymers is modified by introducing long chain branching into the polymer structure which correspondingly improves the melt strength of the propylene-based polymers.

In an embodiment, a process for producing a propylene-based polymer is provided. The process includes reacting a polyamine with a maleic anhydride grafted propylene-based polymer. The reaction between the polyamine and the maleic anhydride grafted propylene-based polymer forms a polyimide-coupled propylene-based polymer. In an embodiment, the reaction occurs by way of melt blending the components.

In an embodiment, the maleic anhydride grafted propylene-based polymer is formed by free radical grafting a functional coagent to the propylene-based polymer. In a further embodiment, the process includes maleating a propylene-based polymer to form the maleic anhydride grafted propylene-based polymer.

The polyamine may be a diamine, a triamine, and/or a tetra-amine. In an embodiment, the polyamine is tris(2-aminoethyl) amine.

The reaction forms a polyimide-coupled propylene-based polymer. The polyimide-coupled propylene-based polymer may have one or more of the following properties: a weight averaged long chain branching index g′_{lcb} less than 0.99, a strain hardening distribution factor less than 0, a strain hardening factor greater than 1.5, a melt flow rate less than 50 g/10 min, a molecular weight distribution from about 3.0 to about 15.0, and/or a gel content from 0 wt % to about 10 wt %, and any combination thereof.

The present disclosure provides a polymer composition. The polymer composition includes a polyimide-coupled propylene-based polymer. The polymer composition may be produced by one or more processes of the present disclosure.

In an embodiment, the polymer composition includes a polyimide linkage that connects a plurality of molecular chains of the propylene-based polymer. In an embodiment, the polyimide linkage connects at least two molecular chains of the propylene-based polymer. In another embodiment, the polyimide linkage connects to at least three chains of the propylene-based polymer. In this way, the polyimide linkage modifies the rheology of the propylene-based polymer by introducing long chain branching thereto.

In an embodiment, the polymer composition has a strain hardening distribution factor (SHDF) less than 0. The SHDF is the slope of the linear regression fit of the strain hardening factor as a function of the logarithm to the basis 10 of the Hencky strain rates between 10 s⁻¹ and 0.1 s⁻¹.

In an embodiment, the polymer composition has one or more of the following properties: a weight averaged long chain branching index less than 0.99, a strain hardening factor greater than 1.5, a melt flow rate less than 50 g/10 min, a molecular weight distribution from about 3.5 to about 4.5, and/or a gel content from 0 wt % to about 10 wt %, and any combination thereof.

The present disclosure provides a foam composition. In an embodiment, a foam composition is provided which includes a polyimide-coupled propylene-based polymer. The foam composition has a density from about 5 kg/m³ to about 850 kg/m³. In a further embodiment, the polyimide-coupled propylene-based polymer has a SHF greater than 1.5.

An advantage of the present disclosure is an improved propylene-based polymer.

An advantage of the present disclosure is a rheology-modified propylene-based polymer with improved properties.

An advantage of the present disclosure is a rheology-modified propylene-based polymer with long-chain branching and improved strain hardening characteristics.

An advantage of the present disclosure is a coupled propylene-based polymer with improved melt strength and/or improved strain hardening characteristics.

An advantage of the present disclosure is an improved foam composition.

### BRIEF DESCRIPTION OF THE DRAWINGS

FIGS. 1A and 1B are graphs showing the strain hardening factor for polymers in accordance with embodiments of the present disclosure.

FIG. 2 is a graph showing the strain hardening distribution factor for polymers in accordance with an embodiment of the present disclosure.

FIG. 3 is a Mark-Houwink plot in accordance with an embodiment of the present disclosure.

### DETAILED DESCRIPTION

In an embodiment, a process for producing a propylene-based polymer is provided. The process includes reacting a polyamine with a functionalized propylene-based polymer. The reaction forms a polyimide-coupled polypropylene.

As used herein, a “polyamine” is a compound having at least two amino groups. In an embodiment, the polyamine has the structure (I):

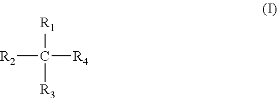

wherein R₁, R₂, R₃, and R₄ may be the same or different. Each of R₁-R₄ is selected from hydrogen, an amino group, a hydrocarbyl having 1 to 20 carbon atoms, a substituted hydrocarbyl having 1 to 20 carbon atoms, a heteroatom, and at least two of R₁-R₄ include at least one amino group.

In an embodiment, at least three of R₁-R₄ include at least one amino group. In another embodiment, each of R₁-R₄ includes at least one amino group.

As used herein, the term “hydrocarbyl” and “hydrocarbon” refer to substituents containing only hydrogen and carbon atoms, including branched or unbranched, saturated or unsaturated, cyclic, polycyclic or acyclic species, and combinations thereof. Nonlimiting examples of hydrocarbyl groups include alkyl-, cycloalkyl-, alkenyl-, alkadienyl-, cycloalkenyl-, cycloalkadienyl-, aryl-, aralkyl, alkylaryl, and alkynyl-groups.

As used herein, the terms “substituted hydrocarbyl” and “substituted hydrocarbon” refer to a hydrocarbyl group that is substituted with one or more nonhydrocarbyl substituent groups. A nonlimiting example of a nonhydrocarbyl substituent group is a heteroatom. As used herein, a “heteroatom” refers to an atom other than carbon or hydrogen. The heteroatom can be a non-carbon atom from Groups IV, V, VI, and VII of the Periodic Table. Nonlimiting examples of heteroatoms include: halogens (F, Cl, I, Br), N, O, P, B, S, Si, Sb, Al, Sn, As, Se and Ge. As used herein, the term “halohydrocarbyl” refers to a hydrocarbyl that is substituted with one or more heteroatoms.

The polyamine may be a diamine, a triamine, a tetra-amine, or a compound with more than four amine groups. The type of polyamine will determine the number of imide linkages at each branch point. For example, a diamine may yield a polyimide linkage connecting two polymer chains at a given branch point, a triamine may yield a polyimide linkage connecting two or three polymer chains a given branch point, and a tetra-amine may yield a polyimide linkage connecting two, three, or four polymer chains at a given branch point.

In an embodiment, the polyamine is a diamine. Nonlimiting examples of suitable diamines include ethylenediamine, butanediamine, 1,5-pentanediamine, and hexamethylenediamine.

In an embodiment, the polyamine is a triamine. Nonlimiting examples of suitable triamines include diethylenetriamine and hexamethylenetriamine.

In an embodiment, the polyamine is a tetra-amine. The tetra-amine may be a tris(aminoalkyl) amine, the alkyl moiety containing 1 to 20 carbon atoms, or 1 to 6 carbon atoms. Nonlimiting examples of suitable tetra-amines include tris(2-aminoethyl) amine, triethylene tetra-amine, hexamethylene tetra-amine, 2,2-bis(aminomethyl)propane-1,3-diamine, 2,3-bis(aminomethyl)butane-1,4-diamine. In a further embodiment, the tetra-amine is tris(2-aminoethyl) amine.

The term “propylene-based polymer,” as used herein is a polymer that comprises a majority weight percent polymerized propylene monomer (based on the total amount of polymerizable monomers), and optionally may comprise at least one polymerized comonomer. The propylene-based polymer may be a propylene homopolymer (i.e., a polypropylene) or a propylene copolymer. The propylene copolymer may be a propylene/olefin copolymer, for example. Nonlimiting examples of suitable olefin comonomers include ethylene, C₄₋₂₀ α-olefins, such as 1-butene, 1-pentene, 1-hexene, 4-methyl-1-pentene, 1-heptene, 1-octene, 1-decene, 1-dodecene and the like; C₄₋₂₀ diolefins, such as 1,3-butadiene, 1,3-pentadiene, norbornadiene, 5-ethylidene-2-norbornene (ENB) and dicyclopentadiene; C₈₋₄₀ vinyl aromatic compounds including styrene, o-, m-, and p-methylstyrene, divinylbenzene, vinylbiphenyl, vinylnapthalene; and halogen-substituted C₈₋₄₀ vinyl aromatic compounds such as chlorostyrene and fluorostyrene.

The propylene-based polymer may be selected from a propylene homopolymer, a propylene/olefin copolymer (random or block), and/or a propylene impact copolymer. The propylene-based polymer may be a reactor polymer or a post-reactor polymer. Any of the foregoing propylene-based polymers may be nucleated or may be non-nucleated. In an embodiment, the propylene-based polymer is a propylene-ethylene copolymer. In another embodiment, the propylene-based polymer is a propylene homopolymer such as a polypropylene.

The propylene-based polymer may be a Ziegler-Natta catalyzed propylene-based polymer, a single-site catalyzed propylene-based polymer, or a nonmetallocene, metal-centered, heteroaryl ligand catalyzed propylene-based polymer. Nonlimiting examples of suitable single site catalysts include metallocene catalysts or constrained geometry catalysts. A “metallocene catalyst” is a catalyst composition containing one or more substituted or unsubstituted cyclopentadienyl moiety in combination with a Group 4, 5, or 6 transition metal.

In an embodiment, the propylene-based polymer is a constrained geometry catalyzed polymer. A “constrained geometry catalyst” (or “CGC”) comprises a metal coordination complex comprising a metal of groups 3-10 or the Lanthanide series of the Periodic Table and a delocalized pi-bonded moiety substituted with a constrain-inducing moiety, said complex having a constrained geometry about the metal atom such that the angle at the metal between the centroid of the delocalized, substituted pi-bonded moiety and the center of at least one remaining substituent is less than such angle in a similar complex containing a similar pi-bonded moiety lacking in such constrain-inducing substituent, and provided further that for such complexes comprising more than one delocalized, substituted pi-bonded moiety, only one thereof for each metal atom of the complex is a cyclic, delocalized, substituted pi-bonded moiety. The constrained geometry catalyst further comprises an activating cocatalyst.

Constrained geometry catalyzed polymers may be produced via a continuous and/or a batch controlled polymerization process using at least one reactor, but can also be produced using multiple reactors to produce polymers with long chain branching. The propylene-based polymer may be catalyzed by way of a constrained geometry catalyst as disclosed in U.S. Pat. No. 5,783,638, the entire content of which is incorporated by reference herein.

In an embodiment, the propylene-based polymer may be a nonmetallocene, metal-centered, heteroaryl or aryl ligand catalyzed propylene-based polymer. A nonmetallocene, metal-centered, heteroaryl or aryl ligand catalyzed propylene-based polymer typically has one or more of the following properties: (i) ¹³C NMR peaks corresponding to a regio-error at about 14.6 and about 15.7 ppm, the peaks of about equal intensity; (ii) isotactic propylene sequences, the sequences having an isotactic triad (mm) measured by ¹³C NMR of greater than about 0.85; (iii) a B-value greater than about 1.4 when the comonomer content, i.e., the units derived from ethylene and/or the unsaturated comonomer(s), of the copolymer is at least about 3 wt %, (iv) a skewness index, Sᵢₓ, greater than about −1.20, (v) a DSC curve with a Tₘₑ that remains essentially the same and a Tₘₐₓ that decreases as the amount of comonomer, i.e., the units derived from ethylene and/or the unsaturated comonomer(s), in the copolymer is increased, and (vi) an X-ray diffraction pattern that reports more gamma-form crystals than a comparable copolymer prepared with a Ziegler-Natta catalyst. Formation of propylene-based polymers by way of a nonmetallocene, metal-centered, heteroaryl or aryl ligand catalyst is disclosed in U.S. Pat. No. 6,906,160, the entire content of which is incorporated by reference herein.

In an embodiment, the propylene-based polymer may be a nitrene-coupled polypropylene. A “nitrene-coupled polypropylene,” as used herein, is a polypropylene with one or more nitrene groups linking two or more polymer chains. In an embodiment, the nitrene-coupled polypropylene is a reaction product of polypropylene and an azide such as a phosphazene azide, a sulfonyl azide, and/or a formyl azide. Azides contain reactive groups capable of forming nitrene groups. The azide may be activated with heat, sonic energy, radiation, or other chemical activating energy, in order to link the polymer chains.

The propylene-based polymer of the present process is a functionalized propylene-based polymer. The term “functionalized propylene-based polymer,” as used herein, refers to the reaction product of a propylene-based polymer with one or more compounds, such as a functional group (also referred to as a “functional coagent”).

The functional group may be any moiety having a carboxyl group (or a derivative thereof) that is capable of forming an imide with the polyamine. Nonlimiting examples of suitable functional coagents include maleic anhydride, succinic anhydride, methyl methacrylate, acrylic acid, methacrylic acid, hydroxyethyl methacrylate, and glycidyl methacrylate. In an embodiment, the functional coagent is maleic anhydride. In a further embodiment, the functionalized propylene-based polymer is maleic anhydride graft propylene-based polymer.

In an embodiment, the process includes grafting a functional coagent to a propylene-based polymer to form the functionalized propylene-based polymer. Grafting may be accomplished as is commonly known in the art. In one embodiment, grafting may occur by way of free radical functionalization. Free radical functionalization typically includes melt blending an olefin-based polymer, a free radical initiator (such as a peroxide or the like), and a functional coagent. During melt blending, the free radical initiator reacts (reactive melt blending) with the propylene-based polymer to form polymer radicals. The functional coagent bonds to the backbone of the polymer radicals to form the functionalized polymer.

As used herein, “melt blending” is a process in which a polymer is softened and/or melted and mixed with one or more other compounds. Nonlimiting examples of melt blending processes include extrusion, melt mixing (batch or continuous), reactive melt blending, and/or compounding. The term “melt processing,” as used herein, is a process whereby a polymer is softened or melted and subsequently manipulated. Nonlimiting examples of melt processes include extruding, pelletizing, molding, blowmolding, thermoforming, film blowing, fiber spinning, and the like. It is understood that melt blending and melt processing may occur simultaneously or sequentially.

In an embodiment, the process includes maleating a propylene-based polymer to form a maleic anhydride-graft-propylene-based polymer. The term, “maleating” or “maleation,” as used herein, is the grafting of maleic anhydride onto the chain of the propylene-based polymer with a free radical initiator at a temperature above the melting point of the propylene-based polymer. Maleation produces a maleic anhydride graft propylene-based polymer (or MAH-g-P). The maleic anhydride may be grafted pendant and/or terminally to the polymer chain. It is understood that once grafted to the polymer chain, the maleic anhydride moiety is a succinic anhydride moiety. In an embodiment, the maleation is controlled to form a MAH-g-P polymer having an average graft per chain of at least about 1.0, or from about 1.0 to about 3.0, or from about 1.2 to about 2.0, or from about 1.4 to about 1.9.

In an embodiment, the process includes solvent-free reacting the polyamine with a MAH-g-P polymer. “Solvent-free reacting,” as used herein, is a reaction between a propylene-based polymer and at least one other reagent, the reaction occurring without dissolution of the propylene-based polymer in a solvent. For example, solvent-free reacting may include reacting the propylene-based polymer while in the melt phase with one or more components (such as polyamine). The propylene-based polymer may be a particulate material or a granular material.

The present process includes reacting the polyamine with the MAH-g-P polymer. The reaction forms a polyimide coupled propylene-based polymer. As used herein, “polyimide coupling” or “polyimide coupled” is the formation of a chemical bond between two or more of the molecular chains of the propylene-based polymer by way of a polyimide linkage, the polyimide linkage including at least two imide moieties. In an embodiment, the reaction between the polyamine and the MAH-g-P polymer occurs by way of melt blending.

In an embodiment, a polyimide linkage connects a plurality of molecular chains of the propylene-based polymer to form a polyimide-coupled propylene-based polymer of the structure (II) as shown below.

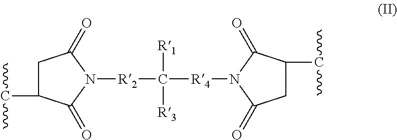

R′₁, R′₂, R′₃, and R′₄ each represent the moiety of the respective R₁, R₂, R₃, and R₄ group for the polyamine of structure (I). R′₁, R′₂, R′₃, and R′₄, may be the same or different, each of R′₁-R′₄ being selected from hydrogen, an amino group, a hydrocarbyl having 1 to 20 carbon atoms, and a substituted hydrocarbyl group having 1 to 20 carbon atoms. It is understood that R′₂ of structure (II) could be the nitrogen moiety of the adjacent imide group whereby “R′₂” would be absent from structure (II). It is similarly understood that R′₄ of structure (II) could be the nitrogen moiety of the adjacent imide group whereby “R′₄” would be absent from structure (II).

In an embodiment, a polyimide linkage connects a plurality of molecular chains of the propylene-based polymer to form a polyimide-coupled propylene-based polymer of the structure (III) as shown below.

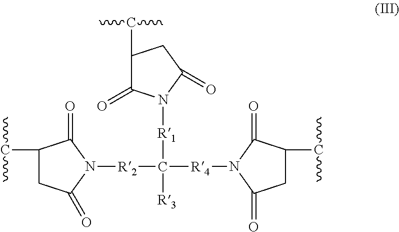

R′₁, R′₂, R′₃, and R′₄ each represent the moiety of the respective R₁, R₂, R₃, and R₄ group for the polyamine of structure (I). R′₁, R′₂, R′₃, and R′₄, may be the same or different, each of R′₁-R′₄ being selected from hydrogen, an amino group, a hydrocarbyl group having 1 to 20 carbon atoms, and a substituted hydrocarbyl group having 1 to 20 carbon atoms. It is understood that R′₁ and/or R′₂ and/or R′₄ of structure (III) could be the nitrogen moiety of the respective adjacent imide group whereby “R′₁” and/or “R′₂” and/or “R′₄” would be absent from structure (III).

In an embodiment, a polyimide linkage connects a plurality of molecular chains of the propylene-based polymer to form a polyimide-coupled propylene-based polymer of the structure (IV) as shown below.

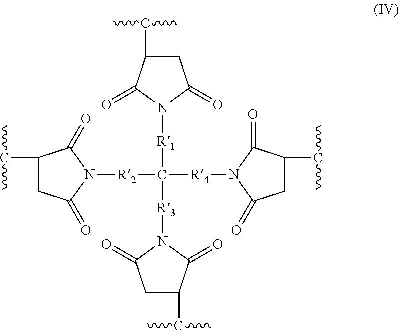

R′₁, R′₂, R′₃, and R′₄ each represent the moiety of the respective R₁, R₂, R₃, and R₄ group for the polyamine of structure (I). R′₁, R′₂, R′₃, and R′₄, may be the same or different, each of R′₁-R′₄ being selected from hydrogen, an amino group, a hydrocarbyl group having 1 to 20 carbon atoms, and a substituted hydrocarbyl group having 1 to 20 carbon atoms. It is understood that R′₁ and/or R′₂ and/or R′₃ and/or R′₄ of structure (IV) could be the nitrogen moiety of the respective adjacent imide group whereby “R′₁” and/or “R′₂” and/or “R′₃” and/or “R′₄” would be absent from structure (IV).

The polyimide coupling of the individual polymer strands results in long chain branching within the propylene-based polymer. A long chain branching index, g′_{lcb} may be used to determine the degree of long chain branching present in the polymer composition. Lower values for g′_{lcb} indicate relatively higher amounts of branching. In other words, if the g′_{lcb} value decreases, the long chain branching of the polymer increases.

It is understood that short chain branching does not contribute to the strain hardening. Strain hardening requires polymer chain entanglement—a phenomenon of LCB. Chain entanglement is not possible with short chain branching.

The “long chain branching index,” “g′_{lcb},” is defined by the following equation (V):

$${g}_{lcb}^{′} = \frac{{IV}_{Br}}{{IV}_{Lin}} {\vert}_{Mw} \qquad ( V )$$

wherein IV_{Br} is the intrinsic viscosity of the branched thermoplastic polymer (e.g., propylene-based polymer) as measured at each elution volume by Triple Detector Gel Permeation Chromatography (GPC). Triple Detector GPC (TD-GPC) (as disclosed in Macromolecules, 2000, 33, 7489-7499 and J. Appl Polym. Sci., 29, 3763-3782 (1984)) uses a 20 micron column and 150° C. temperature for polypropylene (versus a 10 micron column and 145° C. temperature for polyethylene) and in accordance with the GPC analytical method disclosed herein. TD-GPC is used to quantify the degree of long chain branching in a selected thermoplastic polymer.

The term IV_{Lin} is the intrinsic viscosity of the corresponding linear thermoplastic polymer (e.g., propylene-based polymer) as measured at each elution volume by Triple Detector GPC and having substantially the same type and distribution of comonomer units as the branched thermoplastic polymer. As used herein, the term “M_{w}”, is the molecular weight measured by light scattering detector at each elution volume and indicates that the ratio is taken for samples of the same M_{w}. In the present disclosure, grafted propylene-based polymer before coupling is used as the linear thermoplastic polymer.

The weight averaged g′_{lcb} is the weight averaged long chain branching index for the molecular weight range and is specified in equation (VI):

$$weight averaged {g}_{lcb}^{′} = \frac{{\sum }_{Low Limit of Mw specified}^{High Limit of Mw specified} {w}_{i} ⋆ {g}_{lcb}^{′} ( i )}{{\sum }_{Low Limit of Mw specified}^{High Limit of Mw specified} {w}_{i}} \qquad ( VI )$$

wherein wᵢ is the weight fraction at M_{w(i)} in the specified M_{w} range and g_{lcb}′(i) is the LCB index at M_{w(i)}.

In an embodiment, the present polymer composition (i.e., the polyimide-coupled propylene-based polymer) has a weight averaged g′_{lcb} for M_{w} from about 150,000 to about 1,000,000 that is less than 0.99, or from about 0.4 to less than 0.99. A long chain branching index g′_{lcb} within this range advantageously provides a propylene-based polymer with beneficial characteristics such as improved processability and increased melt strength.

In an embodiment, the polyimide-coupled propylene-based polymer has at least two different long chain branched components—a high molecular weight (HMW) component and a low molecular weight (LMW) component.

In an embodiment, the HMW component has an M_{w} greater than about 500,000. The HMW g′_{lcb} at an M_{w} of greater than about 500,000 is less than about 0.99, or from about 0.01 to less than 0.99, or from about 0.40 to about 0.85.

In an embodiment, the LMW component has an M_{w} of less than about 500,000. The LMW g′_{lcb} at an M_{w} less than about 500,000 is less than 0.99, or from about 0.01 to about 0.99, or from about 0.6 to about 0.95.

In an embodiment, the HMW component has a higher (or greater) amount of long chain branching than the LMW component. In other words, the HMW g′_{lcb} value is less than the LMW g′_{lcb} value. The HMW g′_{lcb} value may be from about 0.7 to about 0.92 and the LMW g′_{lcb} value may be from about 0.8 to about 0.95, the HMW g′_{lcb} being less than the LMW g′_{lcb} value.

In an embodiment, a polymer composition is provided. The polymer composition includes a propylene-based polymer having a strain hardening distribution factor (SHDF) less than 0. The polymer composition includes the polyimide-coupled propylene-based polymer which yields unique and distinct melt flow properties.

The strain hardening distribution factor is based on the unique extensional flow of the present polymer composition. Extensional flow, or deformation that involves the stretching of a viscous material, is a common deformation that occurs in typical polymer processing operations. Extensional melt flow measurements are useful in polymer characterization because they are sensitive to the molecular structure of the polymeric system being tested. Polymer materials subject to extensional strain generate a higher degree of molecular orientation and stretching than materials subject to simple shear. As a consequence, extensional flows are sensitive to micro-structural effects, such as long-chain branching, and as such can be far more descriptive with regard to polymer characterization than other types of bulk rheological measurements.

Strain hardening occurs when areas of material which have already been strained become stiffer, transferring subsequent elongation into areas which are unstrained. During strain hardening, the extensional viscosity of the material increases as the strain increases. As used herein, the term “strain hardening factor” (or “SHF”) is the ratio of the extensional viscosity to three times the shear viscosity measured at the same measurement time and at the same temperature. The “measurement time” is defined as the ratio of 3 to the applied Hencky strain rate in the extensional viscosity measurement. For example, the measurement time is 0.3 second for a strain rate of 10 s⁻¹, 3.0 second for a strain rate of 1 s⁻¹ and/or 30 seconds for a strain rate of 0.1 s⁻¹.

The term “Hencky strain,” as used herein, is denoted by \acute{ε} and is defined by the formula \acute{ε}=\acute{ε}_{H}×t, wherein the Hencky strain rate \acute{ε}_{H} is defined by the formula (VII):

$${{ɛ}^{'}}_{H} = \frac{2 \cdot Ω \cdot R}{{L}_{o}} [ {s}^{- 1} ] \qquad ( VII )$$

wherein “Lₒ” is the fixed, unsupported length of the specimen sample being stretched which is equal to the centerline distance between the master and slave drums,

“R” is the radius of the equi-dimensional windup drums, and

“Ω” is a constant drive shaft rotation rate.

The term “shear viscosity,” as used herein, is a measurement of the resistance to flow. A flow field can be established in a system by placing the sample between two parallel plates and then rotating one plate while the other plate remains static. Shear viscosity is determined by the ratio of shear stress to shear rate. For parallel plate setup, shear stress is determined by

$$τ = \frac{2 M}{π {R}^{3}} ,$$

where M is the torque applied by the instrument, R is the radius of the plates. Shear rate is determined by

$$\dot{γ} = \frac{R Ω}{h} ,$$

where Ω is the angular rotation rate and h is the gap between the plates.

In an embodiment, the polymer composition has a strain hardening factor greater than 1.5, or from about 1.5 to about 50, or from about 3 to about 45, or from about 5 to about 40. These SHF values apply to the Hencky strain rate between 10 s⁻¹ and 0.1 s⁻¹. The extensional viscosity is measured at 180° C.

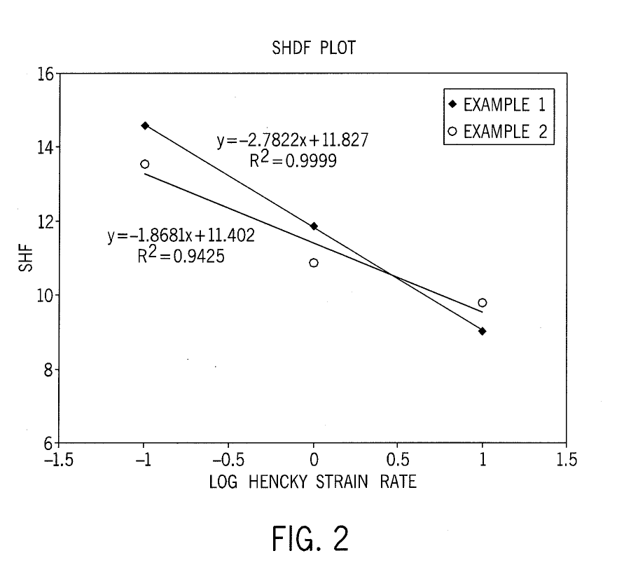

The term “strain hardening distribution factor” (or “SHDF”), as used herein, is the slope of the linear regression fit of the strain hardening factor as a function of the logarithm to the basis 10 of the Hencky strain rates between 10 s⁻¹ and 0.1 s⁻¹. The present polymer composition has a SHDF less than 0 (zero). In other words, the slope of the linear regression fit of the strain hardening factor to the aforementioned log of Hencky strain rate range as herein described is negative as shown in FIG. 2. The SHDF and SHF values for the present polymeric composition are the result of long chain branching (LCB) that is present in the polyimide-coupled propylene-based polymer.

The negative slope for the SHDF indicates that the present polymer composition has a higher (or greater) amount of long chain branching in the HMW component than in the LMW component. Not bound by any particular theory, it is believed that if a material does not show strain hardening, its extensional viscosity should be equal to three times its shear viscosity at the same measurement time and at the same temperature, i.e. SHF should equal one (SHF=1). Any positive deviation from the value of 1 indicates the material shows strain hardening. For polyolefins (such as polyethylene and/or polypropylene) having a linear or a single branched (Y-shaped) polymer chain structure, strain hardening is not expected within the Hencky strain rates from 10 s⁻¹ to 0.1 s⁻¹. Multi-branched molecules, however, can show strain hardening. The extent of the strain hardening can be described by the magnitude or degree of deviation between a material's extensional viscosity data and its shear viscosity data. One way to measure the extent of the strain hardening is to use the SHF values in which extensional viscosity is compared with shear viscosity at the same measurement time. A larger SHF value indicates greater or stronger strain hardening. The extent of the strain hardening is also related to the level of the LCB in the molecules. The stronger the strain hardening, the higher the LCB level is in the molecules.

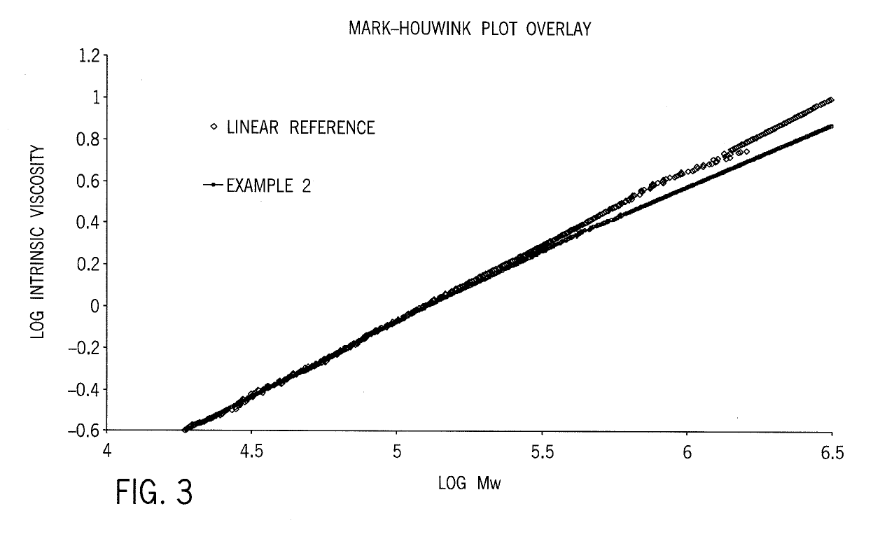

The distribution of the strain hardening across the Hencky strain rates can also indicate the distribution of the LCB in the molecules. Lower Hencky strain rate data correlates to the HMW components. High Hencky strain rates correlates to the LMW components. Therefore, a negative strain hardening distribution factor (SHDF) indicates strain hardening is stronger at low Hencky strain rates than at the high Hencky strain rates (i.e., a higher degree of LCB in the HMW component than in the LMW component). In other words, the LCB level is higher at the high end of the molecular weight distribution (MWD) than at the lower end. This is apparent by the Mark-Houwink plot at FIG. 3.

In an embodiment, the polymer composition including the polyimide-coupled propylene-based polymer has a strain hardening factor greater than 1.5, or from about 1.5 to about 50, or from about 3 to about 45, or from about 5 to about 40. These SHF values apply to the Hencky strain rate of between 10 s⁻¹ and 0.1.

In an embodiment, the process includes forming a polyimide-coupled propylene-based polymer having a gel content less than about 10 wt %, or from about 0 wt % to about 10 wt %, or from about 0.1 wt % to about 5 wt %, or from about 0.5 wt % to about 3 wt %. Weight percent is based on the total weight of the propylene-based polymer. In a further embodiment, the propylene-based polymer may be substantially gel-free or gel-free. As used herein, “substantially gel-free” is a percent gel content that is less than about than about 5 wt %, or less than about 3%, or less than about 2%, or less than about 0.5%. The term “gel-free” is a gel content below detectable limits when using xylene as the solvent.

The average molecular weight and the degree of branching of the polyimide-coupled propylene-based polymer determines the melt flow rate (MFR). This is due to the fact that long molecules yield a material with a lower flow tendency than a material with short molecules. An increase in molecular weight means a decrease in the MFR-value. The polyimide-coupled propylene-based polymer has a MFR less than 50 g/10 MFR, or from about 0.1 g/10 min to about 50 g/10 min as measured in accordance with ASTM D1238 Condition L, 2.16 kg, 230° C.

The present process may comprise two or more embodiments disclosed herein.

The present disclosure provides a polymer composition. The polymer composition includes a polyimide-coupled propylene-based polymer. The polyimide-coupled propylene-based polymer may be any polyimide-coupled propylene-based polymer formed by way of any of the foregoing processes. The propylene-based polymer may be any propylene-based polymer as disclosed herein. In an embodiment, the propylene-based polymer is a propylene homopolymer.

In an embodiment, the polymer composition includes a nitrogen content from about 100 ppm to about 4000 ppm, or from about 250 ppm to about 3000 ppm, or from about 350 ppm to about 2000 ppm. The nitrogen content is based on the total weight of the composition.

In an embodiment, the polymer composition has a molecular weight distribution (MWD) from about 3.0 to about 15.0, or from about 4.0 to 10.0, or from about 5.0 to 9.0.

The polyimide-coupled propylene-based polymer includes a polyimide linkage that connects or otherwise couples a plurality of molecular chains of the propylene-based polymer. Each polyimide linkage may connect two or more, three or more, or four or more, molecular chains of propylene-based polymer.

In an embodiment, the polymer composition includes a propylene-based polymer having a polyimide linkage of structure (II), structure (III), structure (IV), or any combination thereof.

In an embodiment, the polymer composition may have any combination of the following properties: a weight averaged long chain branching index g′_{lcb} less than 0.99; an SHDF less than 0; a strain hardening value of at least 1.5; an MFR of less than 50 g/10 min; a MWD from about 3.0 to about 15.0, and/or a gel content from 0 wt % to about 10 wt %. Values for each property may include any respective subrange as disclosed herein. In a further embodiment, the polymer composition is gel-free, or substantially gel-free.

In an embodiment, the polymer composition includes from about 60 wt % to about 99.5 wt %, or from about 75 wt % to about 99 wt % units derived from propylene weight percent is based on the total weight of the polymer composition.

In an embodiment, any of the polymer compositions may be compounded (or blended, or melt-blended) with one or more of the following: propylene homopolymer, propylene random copolymer, propylene impact copolymer, and any combination thereof.

The present composition may comprise two or more embodiments disclosed herein.

The present polyimide-coupled propylene-based polymers may be used to form a foam. In an embodiment, a foam composition is provided. The foam composition includes a polyimide-coupled propylene-based polymer. The foam composition has a density from about 5 kg/m³ to about 850 kg/m³.

The present polymer composition may be used to form a foam composition. In an embodiment, a foam composition is provided which includes a propylene-based polymer having a strain hardening distribution factor (SHDF) less than 0. The foam composition has a density from about 5 kg/m³ to about 850 kg/m³.

The foam composition may include any polymer composition disclosed herein. In an embodiment, the foam composition includes a silane-coupled propylene-based polymer. The foam composition may have a silicon content from about 0.02 wt % to about 2.0 wt %. Weight percent silicon is based on the total weight of the foam.

In an embodiment, the foam composition includes from about 60 wt % to about 99.5 wt %, or from about 75 wt % to about 99 wt % units derived from propylene. Weight percent units derived from propylene is based on the total weight of the foam composition.

Production of the foam composition may occur sequentially or simultaneously with the silane grafting and/or the moisture curing. For example, a blowing agent (inorganic, organic, and/or chemical) and optionally a nucleating agent may be added to the extruder in which silane grafting and/or in situ moisture curing is performed. Various additives may be incorporated in the present foam composition such as inorganic fillers, pigments, antioxidants, acid scavengers, ultraviolet absorbers, flame retardants, processing aids, extrusion aids, permeability modifiers, antistatic agents, other thermoplastic polymers and the like.

Nonlimiting examples of suitable processes by which the present foam may be formed include a coalesced strand extrusion process, an accumulating extrusion process, and/or a foam bead forming process suitable for molding the beads into articles by expansion or pre-expansion of the beads. In an embodiment, the foam composition is prepared by melt blending in which the propylene-based polymer is heated to form a plasticized or melt polymer material, incorporating therein a blowing agent to form a foamable polymer, and extruding the polymer through a die to form the foam composition.

The present foam composition may be used to make foamed films for bottle labels and other containers using either a blown film or a cast film extrusion process. The films may also be made by a co-extrusion process to obtain foam in the core with one or two surface layers, which may or may not be comprised of the polymer compositions disclosed herein.

The present foam composition has a density from about 5 kg/m³ to about 850 kg/m³. Density is measured in accordance with ASTM D-1622-88.

In an embodiment, the foam composition has an average cell size from about 0.01 mm to about 10 mm, or from about 0.1 mm to about 4.0 mm, or from about 0.2 mm to about 1.8 mm. Average cell size is determined in accordance with ASTM D3576-77.

The present foam composition may be formed into a plank or a sheet, such as one having a thickness or minor dimension in cross-section of 1 mm or more, or 2 mm or more, or 2.5 mm or more, or from about 1 mm to about 200 mm. The foam width may be as large as about 1.5 meter.

In an embodiment, the foam composition has a melt flow rate from about 0.3 g/10 min to about 15 g/10 min, or from about 0.5 g/10 min to less than 10 g/10 min.

In an embodiment, the present foam composition has an open cell content ranging from 0% to about 70%, or from about 5% to about 50%. Open cell content is determined in accordance with ASTM D2856-94.

In an embodiment, the foam composition is gel-free, or substantially gel-free.

The foam composition may comprise two or more embodiments disclosed herein.

The present foam composition may be used in a variety of applications. Nonlimiting examples of such applications include cushion packaging, athletic and recreational products, egg cartons, meat trays, building and construction (e.g., thermal insulation, acoustical insulation), pipe insulation, gaskets, vibration pads, luggage liners, desk pads, shoe soles, gymnastic mats, insulation blankets for greenhouses, case inserts, display foams, etc. Nonlimiting examples of building and construction applications include external wall sheathing (home thermal insulation), roofing, foundation insulation, and residing underlayment. Other nonlimiting applications include insulation for refrigeration, buoyancy applications (e.g., body boards, floating docks and rafts) as well as various floral and craft applications. It should be clear, however, that the foams of this disclosure will not be limited to the above mentioned applications.

Nonlimiting embodiments of the process for producing the propylene-based polymer, the polymer composition and the foam composition are provided below.

The present disclosure provides a process for producing a propylene-based polymer. The process comprises reacting a polyamine with a maleic anhydride grafted propylene-based polymer, and forming a polyimide-coupled propylene-based polymer.

In an embodiment, the process comprises melt blending the maleic anhydride grafted propylene-based polymer with the polyamine.

In an embodiment, the process comprises solvent-free reacting.

In an embodiment, the process comprises maleating a propylene-based polymer and forming a maleic anhydride grafted propylene-based polymer having an average graft per chain from about 1.0 to about 2.5.

In an embodiment, the process comprises reacting the maleic anhydride grafted propylene-based polymer with a member selected from the group consisting of a diamine, a triamine, and a tetra-amine.

In an embodiment, the process comprises forming a polyimide-coupled propylene-based polymer having a weight averaged long chain branching index g′_{lcb} less than 0.99 at the M_{w} range of 150,000 to 1,000,000.

In an embodiment, the process comprises forming a polyimide-coupled propylene-based polymer having a strain hardening distribution factor (SHDF) less than 0. The SHDF is the slope of the linear regression fit of the strain hardening factor as a function of the logarithm to the basis 10 of the Hencky strain rates between 10 s⁻¹ and 0.1 s⁻¹.

In an embodiment, the process comprises forming a polyimide-coupled propylene-based polymer with a gel content from 0 wt % to less than about 10% by weight.

The present disclosure provides a polymer composition. In an embodiment, a polymer composition is provided comprising a polyimide-coupled propylene-based polymer.

In an embodiment, the polymer composition has a strain hardening distribution factor (SHDF) less than 0. The SHDF is the slope of the linear regression fit of the strain hardening factor as a function of the logarithm to the basis 10 of the Hencky strain rates between 10 s⁻¹ and 0.1 s⁻¹.

In an embodiment, the polymer composition has a weight averaged long chain branching index g′_{lcb} less than 0.99 at the M_{w}, range of 150,000 to 1,000,000.

In an embodiment, the polymer composition has a gel content from 0 wt % to about 10 wt %.

In an embodiment, the polymer composition is substantially gel-free.

In an embodiment, the polymer composition comprises a polyimide linkage connecting a plurality of molecular chains of the propylene-based polymer.

The present disclosure provides a foam composition. In an embodiment, a foam composition is provided comprising a polyimide-coupled propylene-based polymer, and the foam has a density from about 5 kg/m³ to about 850 kg/m³.

In an embodiment, the polyimide-coupled propylene-based polymer of the foam composition has a strain hardening distribution factor (SHDF) less than 0. The SHDF is the slope of the linear regression fit of the strain hardening factor as a function of the logarithm to the basis 10 of the Hencky strain rates between 10 s⁻¹ and 0.1 s⁻¹.

In an embodiment, the foam composition has a thickness from about 1 mm to about 200 mm.

In an embodiment, the foam composition comprises an average cell size from about 0.01 mm to about 10 mm as measured in accordance with ASTM D3576-77.

In an embodiment, the polyimide-coupled propylene-based polymer of the foam composition comprises long chain branching.

In an embodiment, the foam composition comprises an open cell content less than about 70%.

### DEFINITIONS

Any numerical range recited herein, includes all values from the lower value and the upper value, in increments of one unit, provided that there is a separation of at least two units between any lower value and any higher value. As an example, if it is stated that a compositional, physical or other property, such as, for example, molecular weight, melt index, etc., is from 100 to 1,000, it is intended that all individual values, such as 100, 101, 102, etc., and sub ranges, such as 100 to 144, 155 to 170, 197 to 200, etc., are expressly enumerated in this specification. For ranges containing values which are less than one, or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this application. In other words, any numerical range recited herein includes any value or subrange within the stated range. Numerical ranges have been recited, as discussed herein, in reference to density, weight percent of component, molecular weights and other properties.

All references to the Periodic Table of the Elements herein shall refer to the Periodic Table of the Elements, published and copyrighted by CRC Press, Inc., 2003. Also, any references to a Group or Groups shall be to the Groups or Groups reflected in this Periodic Table of the Elements using the IUPAC system for numbering groups. Unless stated to the contrary, implicit from the context, or customary in the art, all parts and percents are based on weight. For purposes of United States patent practice, the contents of any patent, patent application, or publication referenced herein are hereby incorporated by reference in their entirety (or the equivalent U.S. version thereof is so incorporated by reference), especially with respect to the disclosure of synthetic techniques, definitions (to the extent not inconsistent with any definitions provided herein) and general knowledge in the art.

The term “comprising,” and derivatives thereof, is not intended to exclude the presence of any additional component, step or procedure, whether or not the same is disclosed herein. In order to avoid any doubt, all compositions claimed herein through use of the term “comprising” may include any additional additive, adjuvant, or compound whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed. The term “or”, unless stated otherwise, refers to the listed members individually as well as in any combination.

The term “composition,” as used herein, includes a mixture of materials which comprise the composition, as well as reaction products and decomposition products formed from the materials of the composition.

The term “polymer” is a macromolecular compound prepared by polymerizing monomers of the same or different type. “Polymer” includes homopolymers, copolymers, terpolymers, interpolymers, and so on. The term “interpolymer” means a polymer prepared by the polymerization of at least two types of monomers or comonomers. It includes, but is not limited to, copolymers (which usually refers to polymers prepared from two different types of monomers or comonomers, terpolymers (which usually refers to polymers prepared from three different types of monomers or comonomers), tetrapolymers (which usually refers to polymers prepared from four different types of monomers or comonomers), and can include polymer blends and interpreting polymer networks as those terms are normally undetected and the like.

The terms “olefin-based polymer” and more specifically “alpha olefin-based polymer” mean a polymer containing, in polymerized form, a majority weight percent of an olefin, for example ethylene or propylene, based on the total weight of the polymer. Nonlimiting examples of olefin-based polymers include ethylene-based polymers and propylene-based polymers.

The term maleic anhydride refers to the following structure

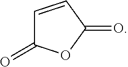

The term “grafted maleic anhydride” refers to a structure bonded to a polymer backbone and/or a grafted coagent, and which contains at least one chemical moiety as shown below, and may include hydrolyzed derivatives and other related structures

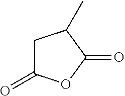

### Test Methods

Extensional Viscosity—is measured by an extensional viscosity fixture (EVF) of TA Instruments (New Castle, Del.) attached onto an ARES rheometer of TA Instruments at Hencky strain rates of 10 s⁻¹, 1 s⁻¹ and 0.1 s⁻¹ at 180° C. Extensional viscosity is measured in Pascal multiple seconds, or Pa·s.

A. Sample Preparation for Extensional Viscosity Measurement

A sample plaque is prepared on a programmable Tetrahedron bench top press. The program holds the melt at 180° C. for 5 minutes at a pressure of 10⁷ Pa. The Teflon® coated chase is then removed to the benchtop to cool. Test specimens are then die-cut from the plaque using a punch press and a handheld die with the dimensions of 10×18 mm² (Width×Length). The specimen thickness is in the range of about 0.7 mm to about 1.1 mm.

B. Extensional Viscosity Measurement

The rheometer oven that encloses the EVF fixture is set to test temperature of 180° C. for at least 60 minutes prior to zeroing fixtures. The width and the thickness of each film is measured at three different locations of the film and the average values are entered into the test program (TA Orchestrator version 7.2). Densities of the sample at room temperature (0.9 g/cm³) and at the test temperature (0.767 g/cm³ at 180° C.) are also entered into the test program to allow for the program to calculate the actually dimensions of the film at test temperature. The film specimen is attached onto each of the two drums of the fixture by a pin. The oven is then closed to let temperature equilibrate before starting test. The test is divided into three zones. The first zone is the pre-stretch zone that stretches the film at a very low strain rate of 0.005 s⁻¹ for 11 seconds. The purpose of this step is to reduce film buckling introduced when the film is loaded as well as to compensate the thermal expansion of the sample when it is heated above room temperature. This is followed by a relaxation zone of 60 seconds to minimize the stress introduced in the pre-stretch step. The third zone is the measurement zone where the film is stretched at the pre-set Hencky strain rate. The data collected in the third zone is used for analysis.

Gel Content—is determined by extracting cured products with refluxing xylenes from 120 mesh sieve cloth. Extraction solutions are stabilized with 100 ppm of BHT, and the procedure is conducted for a minimum of 2 hours, with longer times having no effect on the results. Unextracted material is dried under vacuum to constant weight, with gel content reported as a weight percent of the original sample.

Gel Permeation Chromatography (GPC) Analytical Method—Polymers are analyzed by triple detector gel permeation chromatography (GPC) on a Polymer Laboratories PL-GPC-200 series high temperature unit equipped with refractometer detector, light scattering and online viscometer. Four PLgel Mixed A (20 μm) are used. The oven temperature is at 150° C. with the autosampler hot and the warm zone at 130° C. The solvent is nitrogen purged 1,2,4-trichlorobenzene (TCB) containing 180 ppm 2,6-di-t-butyl-4-methylphenol (BHT). The flow rate is 1.0 ml/min and the injection size is 200 μl. A 2 mg/ml sample concentration is prepared by dissolving the sample in preheated TCB containing 180 ppm BHT for 2.5 hrs at 160° C. with gentle agitation. One or two injections per sample are performed.

The molecular weight determination (MWD) is deduced by using 21 narrow molecular weight distribution polystyrene standards ranging from Mp 580-8,400,000 (Polymer Laboratories). The equivalent polypropylene molecular weights by conventional GPC are calculated by using appropriate Mark-Houwink coefficients for polypropylene. The polydispersity (PDI) is defined as the ratio of weight averaged molecular weight versus the number averaged molecular weight by conventional GPC.

| | Mha | MHk |
|---|---|---|
| Polypropylene | 0.725 | −3.721 |
| Polystyrene | 0.702 | −3.900 |

Melt Flow Rate (MFR)—is measured in accordance with ASTM D 1238-01 test method at 230° C. with a 2.16 kg weight for propylene-based polymers.

Shear Viscosity—Shear viscosity is obtained from dynamic mechanical oscillatory shear measurements.

A. Sample Preparation for Dynamic Mechanical Oscillatory Shear Measurement

Specimens for dynamic mechanical oscillatory shear measurements are prepared on a programmable Tetrahedron bench top press. The program holds the melt at 180° C. for 5 minutes at a pressure of 10⁷ Pa. The chase is then removed to the benchtop to cool down to room temperature. Round test specimens are then die-cut from the plaque using a punch press and a handheld die with a diameter of 25 mm. The specimen is about 3.5 mm thick.

B. Dynamic Mechanical Oscillatory Shear Measurement

Dynamic mechanical oscillatory shear measurements are performed with the ARES rheometer at 180° C. using 25 mm parallel plates at a gap of 1.4 mm with a strain of 10% under an inert nitrogen atmosphere. The frequency interval is from 0.1 to 100 radians/second. Shear viscosity data is converted to a function of time by taking the reciprocal of the angular frequency. A 4^{th}-order polynomial fit is applied to the viscosity-time curve to extend the measurement time to 40 seconds, so that the SHF at 0.1 Hencky strain rate can be calculated.

This is performed prior to calculating SHF.

By way of example and not by limitation, examples of the present disclosure will now be provided.

### EXAMPLES

Materials. An additive-free grade of polypropylene (PP) homopolymer (Mₙ of 55.1 kg/mol and a polydispersity of 5.4) is used. Dicumyl peroxide (DCP, 98%), maleic anhydride (MAH, 99%) tris(2-aminoethyl)amine (TAEA, 96%) are used as received from Sigma Aldrich.

PP powder (3.5 g) is tumble-mixed with a 2 ml of chloroform solution containing the desired amounts of DCP and MAH. The resulting mixture is reacted for 5 minutes under a nitrogen atmosphere within a recirculating twin screw extruder at 180° C. and a screw speed of 60 rpm, yielding a maleic anhydride graft propylene-based polymer (hereafter “MAH-g-P”). All MAH-g-P samples are purified from residual maleic anhydride by dissolving in refluxing xylene, precipitating from acetone, and drying under vacuum at 60° C. Grafted maleic anhydride contents are calculated from the area derived from the 1754-1808 cm⁻¹ C═O anhydride absorbance relative to a 422-496 cm⁻¹ internal standard region originating from PP.

Polyimide-coupled MAH-g-P polymer. Purified MAH-g-P samples for amine-curing are stabilized with 500 ppm Irganox-1010, 1000 ppm Irgafos-168 and 600 ppm calcium stearate. Coupling of ground, stabilized MAH-g-P (3.5 g) is accomplished by casting a chloroform solution containing 0.33 molar equivalents of tris(2-aminoethyl)amine (TAEA) relative to the anhydride content of the sample. The powder is tumble-mixed to remove residual chloroform, and the resulting masterbatch is reacted in a twin screw extruder at 180° C., 60 rpm for 5 minutes, yielding polyimide-coupled MAH-g-P polymer (hereafter “LCB-Im”).

Table 1 below provides properties for two examples of LCB-Im as prepared above.

TABLE 1

| | Example 1 | Example 2 |
|---|---|---|
| DCP (Dicumyl peroxide) | 0.05 wt % | 0.1 wt % |
| MAH (Maleic anhydride) - added | 0.50 wt % | 0.50 wt % |
| MAH (Maleic anhydride) - grafted | 0.34 wt % | 0.50 wt % |
| TAEA (Tris(2-aminoethyl) amine | 0.167 wt % | 0.246 wt % |
| Mw by conventional GPC (g/mol) | 128,000 | 121,700 |
| PDI | 4.0 | 3.9 |
| g′_{lcb} at M_{w} of 500,000 g/mol | 0.862 | 0.907 |
| g′_{lcb} at M_{w} of 1,000,000 g/mol | 0.773 | 0.82 |
| Weight averaged g′_{lcb} at M_{w} from | 0.946 | 0.956 |
| 150,000 to 1,000,000 g/mol | | |
| Gel fraction (xylene insoluble) | 0.7 wt % | 1.6 wt % |
| SHF at 0.1 s⁻¹ | 14.59 | 13.54 |
| SHF at 1.0 s⁻¹ | 11.86 | 10.87 |
| SHF at 10 s⁻¹ | 9.03 | 9.8 |
| SHDF | −2.78 | −1.87 |

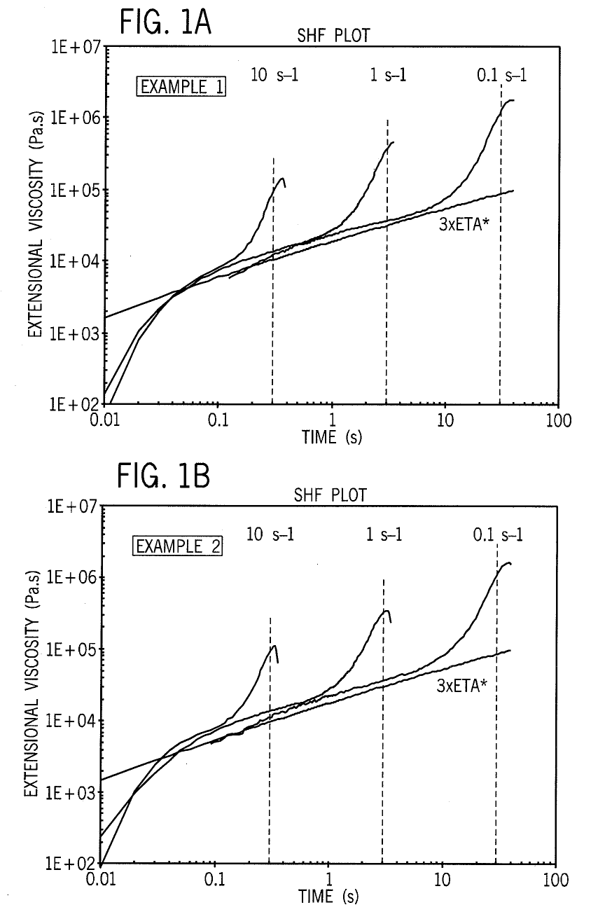

A graph showing the SHF values for Examples 1 and 2 is set forth at FIG. 1. A Mark-Houwink plot for Examples 1 and 2 is set forth at FIG. 3.

It is specifically intended that the present disclosure not be limited to the embodiments and illustrations contained herein, but include modified forms of those embodiments including portions of the embodiments and combinations of elements of different embodiments as come within the scope of the following claims.

1. A process for producing a propylene-based polymer comprising:
reacting a polyamine with a maleic anhydride grafted propylene-based polymer; and
forming a polyimide-coupled propylene-based polymer.

2. The process of claim 1 wherein the reacting comprises melt blending the maleic anhydride grafted propylene-based polymer with the polyamine.

3. The process of claim 1 comprising maleating a propylene-based polymer and forming a maleic anhydride grafted propylene-based polymer having an average graft per chain from about 1.0 to about 2.5.

4. The process of claim 1 comprising reacting the maleic anhydride grafted propylene-based polymer with a member selected from the group consisting of a diamine, a triamine, and a tetra-amine.

5. A polymer composition comprising:
a polyimide-coupled propylene-based polymer.

6. The polymer composition of claim 5 having a strain hardening distribution factor (SHDF) less than 0, wherein the SHDF is the slope of the linear regression fit of the strain hardening factor as a function of the logarithm to the basis 10 of the Hencky strain rates between 10 s⁻¹ and 0.1 s⁻¹.

7. The polymer composition of claim 5 having a weight averaged long chain branching index g′_{lcb} less than 0.99 at the M_{w} range of 150,000 to 1,000,000.

8. The polymer composition of claim 5 having a gel content from 0 wt % to about 10 wt %.

9. A foam composition comprising:
a polyimide-coupled propylene-based polymer; and
the foam having a density from about 5 kg/m³ to about 850 kg/m³.

10. The foam composition of claim 9 wherein the polyimide-coupled propylene-based polymer comprises long chain branching.
